(19) United States
(12) Patent Application Publication
(10) Pub. No.: US 2008/0191075 A1
(43) Pub. Date: Aug. 14, 2008

(54) Device for Pruning and Shredding Plants

(76) Inventor: Alain Guy Georges Bon, Euilly et Lombut (FR)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 11/914,921

(22) PCT Filed: Jul. 10, 2006
(86) PCT No.: PCT/FR06/50701

§ 371 Date: Nov. 19, 2007

(30) Foreign Application Priority Data
Jul. 11, 2005 (FR) 0552142
Aug. 5, 2005 (FR) 0552447
Aug. 31, 2005 (FR) 0552618

(51) Int. Cl. A01G 23/093

(52) U.S. Cl. 241/235; 241/101.71

(57) ABSTRACT

The invention concerns a device for pruning and shredding plants. It comprises a shredding head (1) arranged at the end of a steerable arm itself borne by a tractor machine adapted to move along the plants to be treated, the head comprising a housing (10) including two parallel end plates (11, 12) between which are mounted two juxtaposed rotors (13, 14) with parallel axes, equipped with radial blades (15) and adapted to be driven in rotation in opposite directions (F, R), such that the blades (15) of said rotors (13, 14) move in the space (16) which separates said rotors (13, 14) and drive therein the plants to be cut and shredded.

### BACKGROUND OF THE INVENTION

(1) Field of the Invention

The present invention relates to a device for pruning and shredding plants.

The maintenance of the surrounding areas of roads and forest tracks or the like requires periodic pruning operations, which, in turn, give rise to plant-shredding operations in order to allow the removal and the transport of waste obtained.

(2) Description of the Prior Art

The pruning operations are generally carried out by means of bucking saws or the like, which are carried by hand or mounted on tractor machines, while the shredding occurs afterwards by means of plant shredders.

Traditional manual cutting tools, or brush shredders, which are however ineffective when the branches exceed a certain cross-section, are also used.

Pruning is a slow operation, and when high hedges or trees along traffic roads are to be treated, this can result into a slowing-down of the traffic.

In addition, since shredding is an operation separated from the pruning operation, this increases the above-mentioned drawbacks.

The aim of the present invention is to cope with these various drawbacks by providing a device for pruning and shredding plants, permitting not only to carry out these two operations simultaneously, but also to carry them out at a rate never reached before.

### SUMMARY OF THE INVENTION

The device for pruning and shredding plants according to the invention includes a shredding head arranged at the end of a steerable arm itself borne by a tractor machine capable of moving along the plants to be treated, said head including a housing comprising two parallel end plates between which are mounted two juxtaposed rotors with parallel axes, equipped with radial blades and capable of being driven in rotation in opposite directions, so that the blades of said rotors move in the space which separates said rotors and drive therein the plants with a view to their cutting and shredding.

According to an additional feature of the pruning and shredding device according to the invention, one of the two end plates, the one aimed at being placed closest to the plants, is largely indented.

According to another additional feature of the pruning and shredding device according to the invention, one of the end plates, the one aimed at being placed farthest away from the plants, is extended with a deflector capable of containing and guiding said plants towards the rotors.

According to another additional feature of the pruning and shredding device according to the invention, the rotors each comprise a body in the form of a relatively large-diameter cylinder from which the blades protrude.

According to another additional feature of the pruning and shredding device according to the invention, at least one of the rotors is associated with counter-blades arranged at the level of an end plate at the inlet of the space separating said rotors.

According to another additional feature of the pruning and shredding device according to invention, it comprises counter-blades arranged in front of the space separating the rotors, and which each present an active edge that preferably coincides with the axis passing through the two axes of the rotors, so as to be parallel to the blades 15 when the latter intersect said counter-blades.

According to another additional feature of the pruning and shredding device according to the invention, it comprises a scraper arranged in front of the space separating the rotors, designed capable of pivoting according to an axis parallel to those of the rotors, so as to be capable of adopting several positions between two end positions, one corresponding to the scraping of a rotor and the other to the scraping of the other rotor.

According to another additional feature of the pruning and shredding device according to the invention, it is provided with scraping means integral with the housing, in the form of combs between the teeth of which the blades pass.

According to another additional feature of the device of pruning and shredding according to the invention, the housing internally comprises means capable of slowing down the progression of the plant material after its passing through the space separating the rotors.

According to another additional feature of the pruning and shredding device according to the invention, the housing comprises openings positioned in front of each rotor and aimed at evacuating the shred, said openings being provided with deflector means capable of directing the flow of shred.

According to another additional feature of the pruning and shredding device according to the invention, the steerable arm is designed capable of being made integral with a tractor machine, and it has at least two, preferably at least three, degrees of freedom, so as to permit placing the shredding head according to different orientations and at different heights.

The advantages and characteristics of the pruning and shredding to device according to the invention will clearly appear from the following description, which refers to the attached drawing, which represents a non-restrictive embodiment of same.

### BRIEF DESCRIPTION OF THE DRAWING

In the attached drawing:

FIG. 1 shows a schematic side view of part of the device for pruning and shredding plants according to 1′ invention.

FIG. 2 shows a schematic view according to another angle of the same device.

FIG. 3 shows a schematic perspective view of the same device.

FIG. 4 shows a schematic side view of a variant of part of the same device.

FIG. 5 shows a schematic partial perspective view of an element of the same device.

### DETAILED DESCRIPTION OF THE PREFERRED EMBODIMENTS

When referring to these figures, one can see that a device for pruning and shredding plants according to the invention comprises a head 1 mounted at the end of a hinged arm 2, which can be seen in FIG. 2.

The head 1 comprises a housing 10 including two end plates 11 and 12, which enclose and maintain two rotors 13 and 14 with parallel axes each comprising a cylindrical body provided with radial blades 15, schematically shown and separated by a space 16 in which the blades 15 move.

The two rotors 13 and 14 are driven in opposite rotation, in the direction of the arrows F and R, respectively, so as to drive the plants into the space 16, and to propel them into the housing 10 with a view to performing its shredding.

The blades 15 are preferably regularly distributed over the full surface of the bodies of the rotors 13 and 14, so as not to favour the jamming phenomena.

In order to increase the quality of shredding, the housing 10 is internally provided with means 10′ capable of slowing down the progression of the plant material, so as to increase the duration of presence of the latter in the area of action of the blades 15.

These means can for example consist of bars protruding out of the internal face of the housing 10 parallel to the axes of the rotors 13 and 14, and extending between the two end plates 11 and 12.

The head 1 also includes scraping elements 17 integral with the housing 1, and which extend between the blades 15, in order to enter almost into contact with the bodies of the rotors 13 and 14.

The head 1 has at each of its ends, i.e. on both sides of the rotors 13 and 14, an opening 18 allowing evacuating the shred.

It should be noted that it is perfectly possible to associate to the head 1 means for collecting and evacuating the shred.

The hinged arm 2, which is in this case made integral with the end plate 12, permits moving the head 1 with respect to the plants, and namely so that the end plate 11 remains substantially parallel to the direction of displacement and to the plants. The hinged arm 2 has several degrees of freedom, at least two, preferably three.

It is thus possible to treat vertical plant walls such as hedges or the like, but also horizontal surfaces, by moving the head 1 of the end plate 11 parallel to the ground.

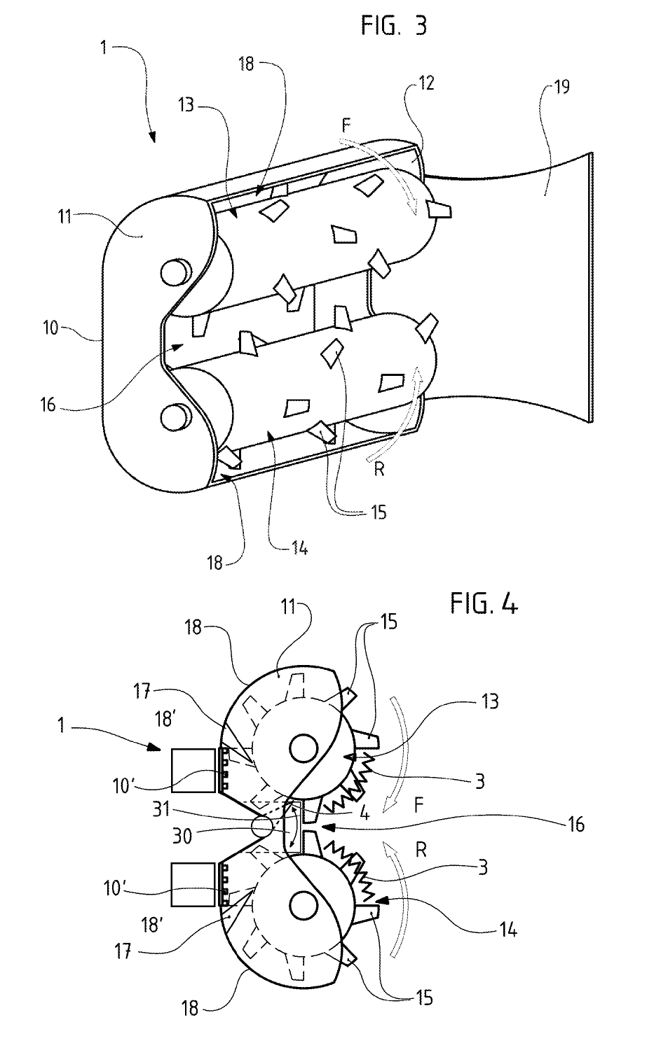

It should be noted, as can be seen in particular in FIG. 3, that the end plate 11 is largely indented in order to allow an increased penetration into the plants, unlike the end plate 12, which thus permits to contain the protrusions.

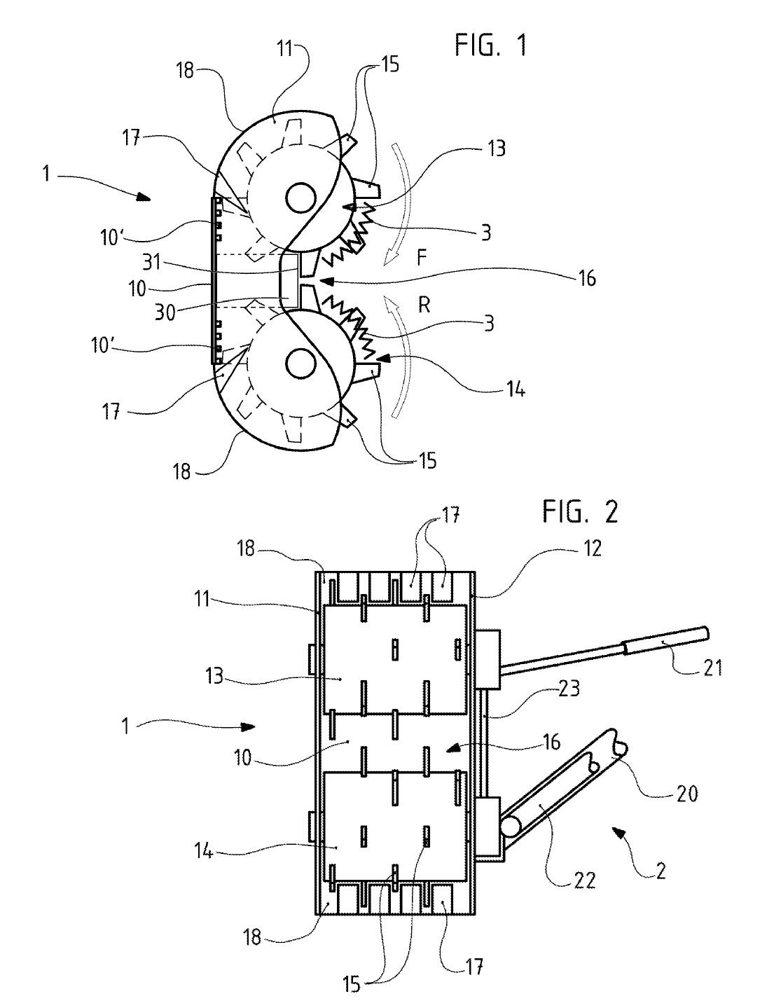

It is furthermore possible to provide the head 1 with counter-blades 3, schematically shown in FIG. 1, aimed at facilitating the cutting of the plants. These counter-blades 3 can consist of an extension of the end plate 11 in the area of the space 16, and having, for each rotor 13 and 14, a toothed edge concentric to the rotor involved, and with a radius ranging between that of the body of the rotor and that of the blades 15.

It should be noted that the head 1 is, optionally, also provided with counter-blades 30, visible in FIG. 1, arranged in front of the space 16, and which each have an active edge 31, which preferably coincides with the axis passing through the two axes of the rotors 13 and 14, so as to be parallel to the blades 15 when the latter intersect with the counter-blades 30.

In FIG. 3, one can also see that the end plate 12 is extended, at the front, i.e. at the side from which the blades 15 emerge, with a deflector 19 capable of containing and guiding the plants.

The hinged arm 2 mainly comprises an arm 20 movable according to a to-and-fro motion and made integral with the head 1 in front of the rotor 14, and a jack 21 the end of which is made integral with the head 1 in front of the rotor 13, and which is aimed, according to its lengthening or its shortening, at changing the inclination of the head 1.

The arm 20 is backed up with a driving shaft 22, which transmits the motion to the rotor 14, while a transmission shaft 23 allows driving the rotor 13.

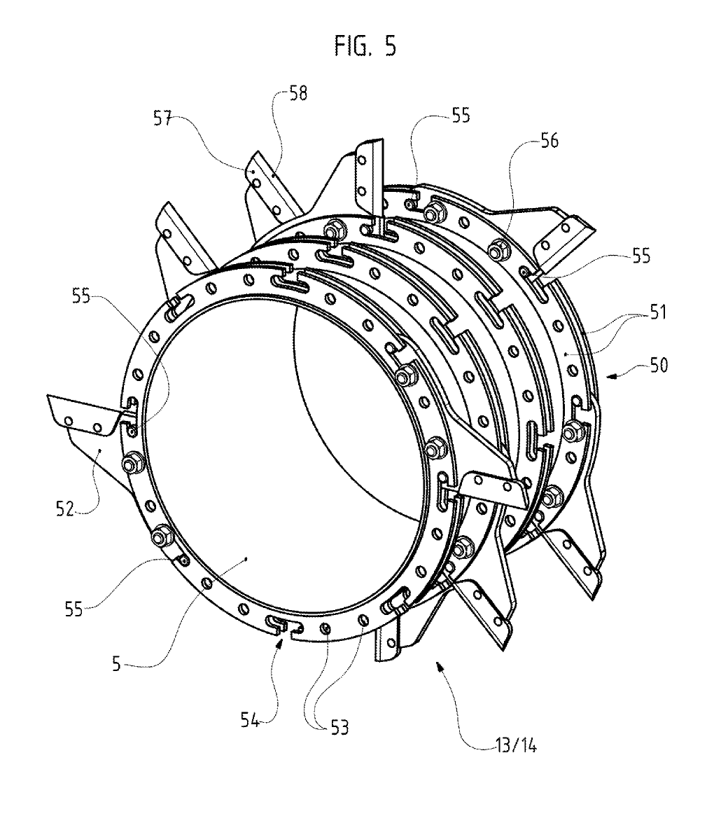

When referring to FIG. 4, one can see a different embodiment of the head 1.

Thus, the openings 18, not visible, aimed at evacuating the shred, are brought closer to the median area of the housing, and each end in front of a flap 18′, which is steerable according to an axis perpendicular to those of the rotors 13 and 14. It is therefore possible, by causing the flaps 18′ to pivot, to steer the flow of shred.

It should be noted that the flaps can be replaced by chutes, also steerable, which each cover an opening 18, thus allowing conveying the flow of shred.

Furthermore, the head 1 includes in addition a scraper 4, arranged in front of the space 16, and which acts between the counter-blades 18′, this scraper 4 being designed so as to pivot according to an axis parallel to those of the rotors 13 and 14, so as to be capable to adopting two end positions, one corresponding to the scraping of the rotor 13 and the other to the scraping of the rotor 14.

It should be understood that this scraper 4 also acts as a deflector, since, according to the end position chosen, the plants are directed towards either one of the rotors 13 and 14. On the other hand, by positioning the scraper 4 between both end positions, the plants are directed simultaneously towards both rotors 13 and 14.

When referring now to FIG. 5, one can see a rotor 13 or 14, which consists of a barrel 5 externally provided with pairs 50 of crowns 51, aimed at making integral the blade-holders 52. The crowns 51 are drilled with holes 53 and includes notches 54, while the blade-holders 52 each include, on the one hand, two pins 55, one at each end, and, on the other hand, holes, not visible.

Each blade-holder 52 is inserted between two crowns 51 of a pair 50, the pins 55 are inserted into the notches 54 and are aimed at bearing the shearing forces, the making integral being performed by means of bolts 56.

It should be noted that the notches 54 have a symmetrical shape, so as to allow fixing the blade-holders 52 in one direction or in the other.

The blade-holders 52 are each provided with a blade 57, which has a bevel 58. As can also be seen in FIG. 5, the bevels 58 are oriented towards the inside of the rotor, so as to maintain the plants and thus guarantee an optimal shredding.

Thus, the embodiment which has been described above comprises a pair of rotors, whereas it is perfectly possible that it comprises several pairs of them.

On the other hand, the two rotors shown are of an identical size, whereas depending on the use for which the device is intended, the two rotors can be of different diameters, in order to favour, on the side of the largest rotor, a direction of propelling of the plants.

1. Device for pruning and shredding plants, including a shredding head arranged at the end of a steerable arm itself borne by a tractor machine capable of moving along the plants to be treated, said head including a housing comprising two parallel end plates between which are mounted two juxtaposed rotors with parallel axes, equipped with radial blades and capable of being driven in rotation in opposite directions, so that the blades of said rotors move in the space which separates said rotors and drive therein the plants with a view to their cutting and shredding.

2. Device for pruning and shredding according to claim 1, wherein one of the two end plates, the one aimed at being placed closest to the plants, is largely indented.

3. Device for pruning and shredding according to claim 1, wherein one of the end plates, the one aimed at being placed farthest away from the plants, is extended with a deflector capable of containing and guiding said plants towards the rotors.

4. Device for pruning and shredding according to claim 1, wherein the rotors each comprise a body in the form of a relatively large-diameter cylinder from which the blades protrude.

5. Device for pruning and shredding according to claim 1, wherein each of the shredders consists of a barrel externally provided with pairs of crowns, aimed at making integral blade-holders, each of which is inserted between two crowns of a pair, locked in place by means of pins and fixed by bolts.

6. Device for pruning and shredding according to claim 1, provided with scraper means integral with the housing, in the form of combs between the teeth of which the blades pass.

7. Device for pruning and shredding according to claim 1, wherein the housing internally includes means capable of slowing down the progression of the plant material after its passing into the space separating the rotors.

8. Device for pruning and shredding according to claim 6, wherein the means capable of slowing down the progression of the plant material consist of bars protruding out of the inner face of the housing parallel to the axes of the rotors and, and extending between the two end plates.

9. Device for pruning and shredding according to claim 1, wherein at least one of the rotors is associated with counter-blades arranged at the level of an end plate at the inlet of the space separating said rotors.

10. Device for pruning and shredding according to claim 1, comprising counter-blades arranged in front of the space separating the rotors, and each having an active edge, which preferably coincides with the axis passing through the two axes of said rotors, so as to be parallel to the blades when the latter intersect said counter-blades.

11. Device for pruning and of shredding according to claim 1, including a scraper arranged in front of the space separating the rotors, designed so as to pivot according to an axis parallel to those of the rotors, so as to be capable of adopting several positions between two end positions, one corresponding to the scraping of a rotor and other to the scraping of the other rotor.

12. Device for pruning and shredding according to claim 1, wherein the housing includes openings positioned in front of each rotor and aimed at evacuating the shred, said openings being provided with deflector means capable of directing the flow of shred.

13. Device for pruning and shredding according to claim 1, wherein the steerable arm is designed capable of being made integral with a tractor machine, and has at least two, preferably at least three, degrees of freedom, so as to allow placing the shredding head according to various orientations and at various heights.
